(19) United States
(12) Patent Application Publication
(10) Pub. No.: US 2006/0056390 A1
(43) Pub. Date: Mar. 16, 2006

(54) Public network system of payment mode using a card with a chip

(75) Inventor: Wallers Lin, Taipei (TW)

Correspondence Address: BRUCE H. TROXELL, SUITE 1404, 5205 LEESBURG PIKE, FALLS CHURCH, VA, 22041, US

(73) Assignee: Bantex Corporation

(21) Appl. No.: 10/937,269

(22) Filed: Sep. 10, 2004

(51) Int. Cl. H04L 12/66

(52) U.S. Cl. 370/352

(57) ABSTRACT

The public network system mainly provides a proxy server, a gatekeeper and a billing system at a server end through an IP network with an H.323 Voice Over Internet Protocol Gateway and a trunk gateway, and provides H.323 public network telephones and soft phones having card readers at particular locations or large chain stores at customer ends. A user only needs to insert a card with a chip into a card reader, and he can dial on a telephone through the IP network and authorization of the server end. Thereby, by the convenience that a entity public network telephone system is constructed at particular locations or large chain stores, and through an on-line payment system, money saving communication services can be provided for outdoor entities to dial city phone calls, international or long-distance cell phone calls.

### BACKGROUND OF THE INVENTION

1. Field of the invention

The present invention is related to a public network system of a payment mode using a card with a chip, and especially to a system that can publicize a telephone of a network.

2. Description of the Prior Art

After development of Internet, a brand-new measure of voice communication was established; in which an Internet Protocol Telephony (in short, IP phone) making communication taking advantage of a local area network (LAN) has been fast and prosperously developing in the field of electric communication. A user of an IP phone can make voice connection with another IP phone through the H.323 protocol of an IP network.

A systematic construction 200 as shown in FIG. 6 can make connection of multiple IP networks through a router 201. An H.323 terminal 202 on each IP network can get a function of conversation through a call server on the network, and can be communicated with a network 204 such as an Integrated Service Digital Network (ISDN) etc. not belonging to the H.323 protocol, through an H.323 gateway 203. A gatekeeper 205 controls the gateway 203.

However, a normal telephone of a network available presently adopts a closed network audience, and can only get communication by simultaneously having an IP network and an IP phone; moreover, in such a normal network telephone system, there is no outdoor call station provided for public using, in short, this is just like a normal network for telephones having no public telephone, which is inconvenient for practical use.

Further, the modes of fee collecting of normal network telephones are traditional modes of management including the modes of monthly payment debits and telephone fee payments via remission in advance, these are inconvenient as compared with a card with a chip popularized in the modern time.

### SUMMARY OF THE INVENTION

Therefore, the primary object of the present invention is to provide a public network system of a payment mode using a card with a chip, its mode of management is publicizing of an IP phone, namely, it takes advantage of the convenience of the network for specific locations or for large chain stores to establish telephone nets of an entity public network, and provides outdoor particular public network telephones through an on-line payment system for providing money-saving communication services including calling phone calls in a city, internationally and long-distance phone calls with cell phones.

A further object of the present invention is to provide a public network system of a payment mode using a card with a chip, the system allows on-line instant payment on the network via an IC card with a chip and a credit card for instance, this is different from the traditional modes of management including the modes of monthly payments and telephone fee payments via remission in advance of a normal network telephone adopting a closed network audience without an outdoor call station.

The systematic construction of the present invention mainly provides a proxy server, a gatekeeper and a billing system (billing (DB)) at the server end through an IP network with an H.323 Voice Over Internet Protocol Gateway (briefly as VoIP gateway) and a trunk gateway, and provides H.323 public network telephones (IP phone) or soft phones having card readers at particular locations or large chain stores at customer ends. A user only needs to insert a card with a chip into a card reader, and he can call on a public network telephone through an IP network and by authorization of the server end.

The present invention will be apparent in its systematic construction and operation in starting and finishing conversation after reading the detailed description of the preferred embodiment thereof in reference to the accompanying drawings.

### BRIEF DESCRIPTION OF THE DRAWINGS

FIG. 1 is a schematic view showing the construction of a preferred embodiment of the present invention;

FIG. 2 is a schematic view showing starting and finishing conversation with the present invention;

FIG. 3 is a flow chart showing starting and finishing conversation with the present invention;

FIG. 4 is a schematic view showing finishing of conversation with the present invention;

FIG. 5 is a flow chart showing finishing of conversation with the present invention; and

FIG. 6 is a schematic view showing an H.323 construction.

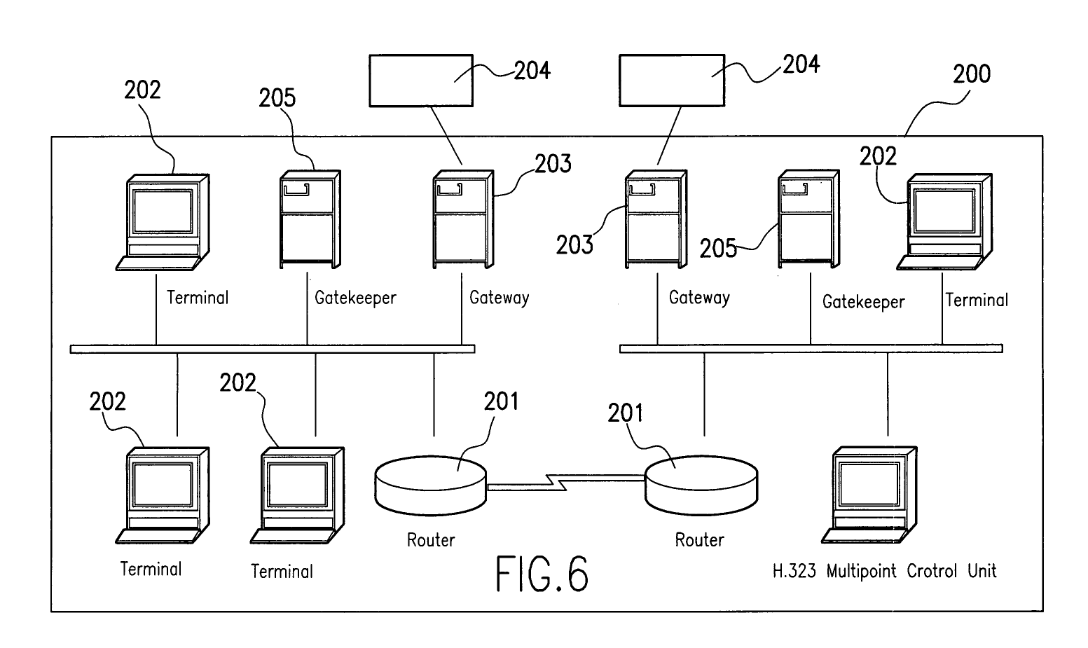

### DETAILED DESCRIPTION OF THE PREFERRED EMBODIMENT

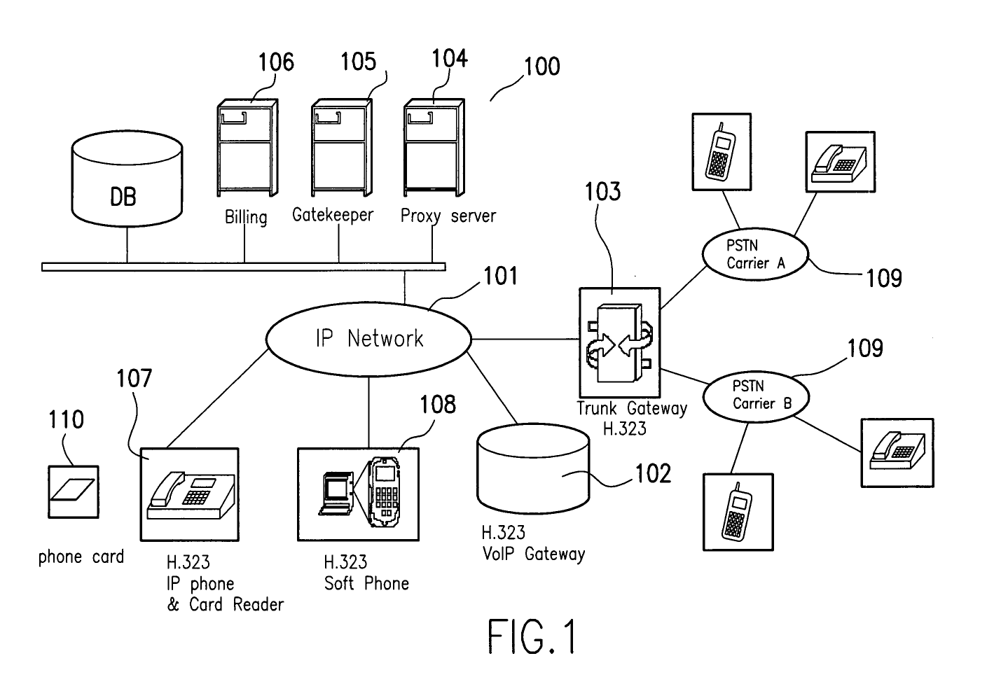

Referring to FIG. 1, a system 100 of the present invention mainly provides a proxy server 104, a gatekeeper 105 and a billing system 106 at the server end through an IP network 101 having an H.323 Voice Over Internet Protocol Gateway 102 and a trunk gateway 103, and provides at least an H.323 public network telephone 107 and an H.323 soft phone 108 having card readers at particular locations or large chain stores at customer ends.

The main function of the trunk gateway 103 resides in providing message conversion or communication-procedure conversion between the H.323 system and a different protocol standard, for instance, a Public Switch Telephone Network company 109 (PSTN Carrier A or B). And the different protocol standards can also be Integrated Service Digital Networks (ISDN). Thereby, communicable instant two-way line connection can also be established for different network end-points.

For the convenience of reading, the devices in the system are specified in the first place as follows:
1. The gatekeeper 105: provides an entire H.323 local control system, and provides communication managing service for a user to make registration.
2. The proxy server 104 (H.323 proxy): provides the function of address conversion; when an H.323 IP phone of a user is a Private IP address, he can only make communication with a remote telephone through the H.323 proxy.
3. The billing system 106 (Billing (DB)): provides information of billing of line connecting.
4. The H.323 public network telephone 107: is a telephone used at the customer's end, the functions it provides include a kind of capability for channel coordination, line connection control and data purification, and a kind of function of a coder element being charged with providing the ability of compressing and decompressing for sound communication.
5. The trunk gateway 103: the primary function of the gateway in the H.323 system provides message conversation or communication-procedure conversion between different protocol standards; the object of the gateway is to make communicable instant two-way line connection for different network end points of a Local Area Network (LAN) with those of a Public Switch Telephone Network company (PSNT) and an Integrated Service Digital Network (ISDN) etc.

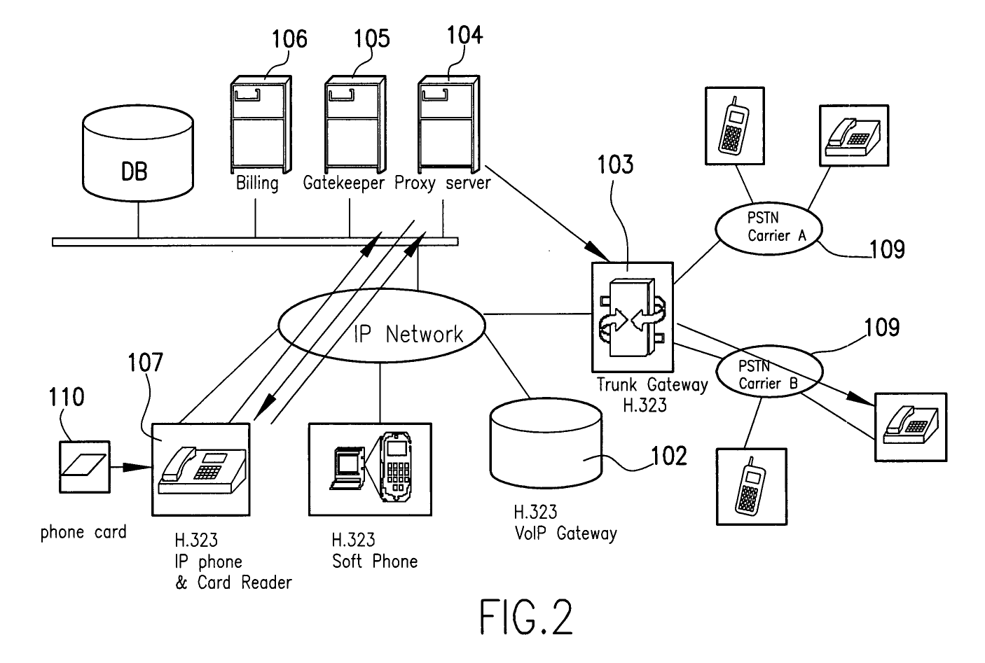

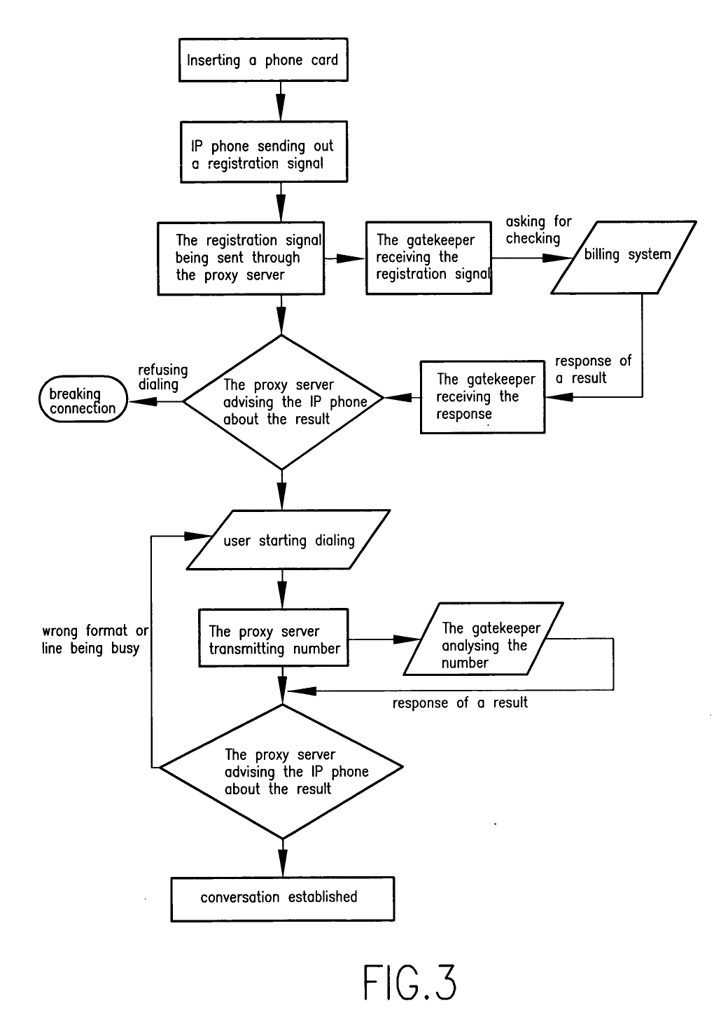

And more, referring to FIGS. 2 and 3, the execution procedure of starting conversation of the present invention is specified as below, wherein the numbers of articles are corresponding to numbers marked in FIG. 2.
1. A phone card 110 is inserted into a card reader.
2. The card reader sends out a registration signal.
3. The registration signal is sent to the gatekeeper 105 through the proxy server 104.
4. The gatekeeper 105 asks the billing system 106 to check the state of the account after receiving the registration signal.
5. The billing system 106 responds to the gatekeeper 105 about the state of the account.
6. The gatekeeper 105 decides whether dialing is permitted after receiving the response.
7. The gatekeeper 105 sends the result back to the public network telephone 107.
8. The user starts to dial.
9. The proxy server 104 analyses the destination number through the gatekeeper 105.
10. The gatekeeper 105 notices the proxy server 104 after analysis.
11. The proxy server 104 establishes a conversation path with the trunk gateway 103 according to the analysis of the gatekeeper 105.
12. The trunk gateway 103 asks the local Public Switch Telephone Network company 109 to establish communication with the telephone of the destination number.

Then the function of conversation is successfully achieved.

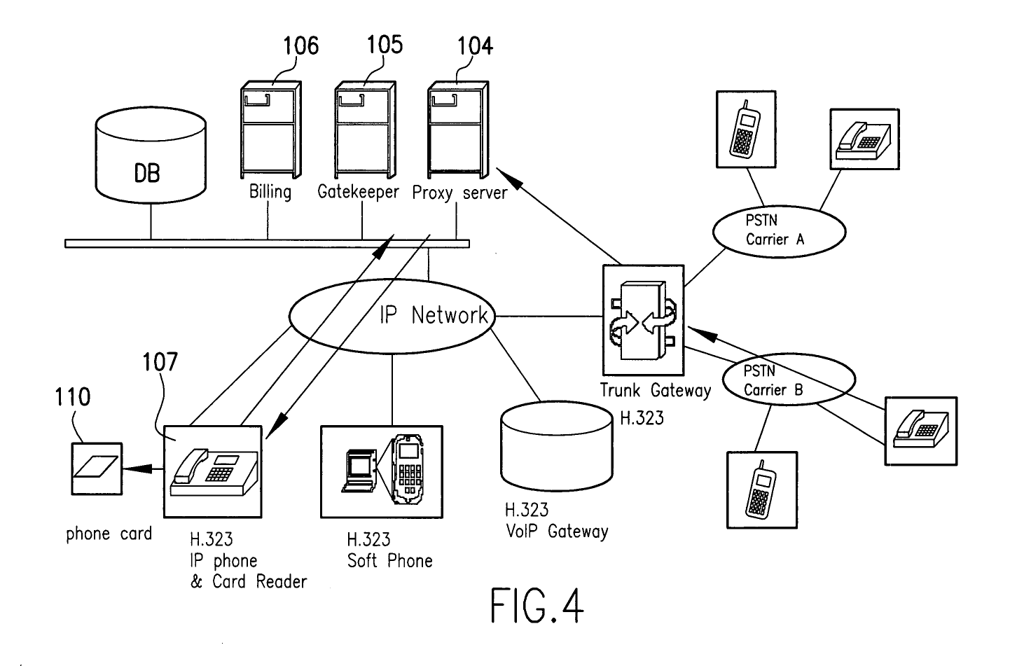

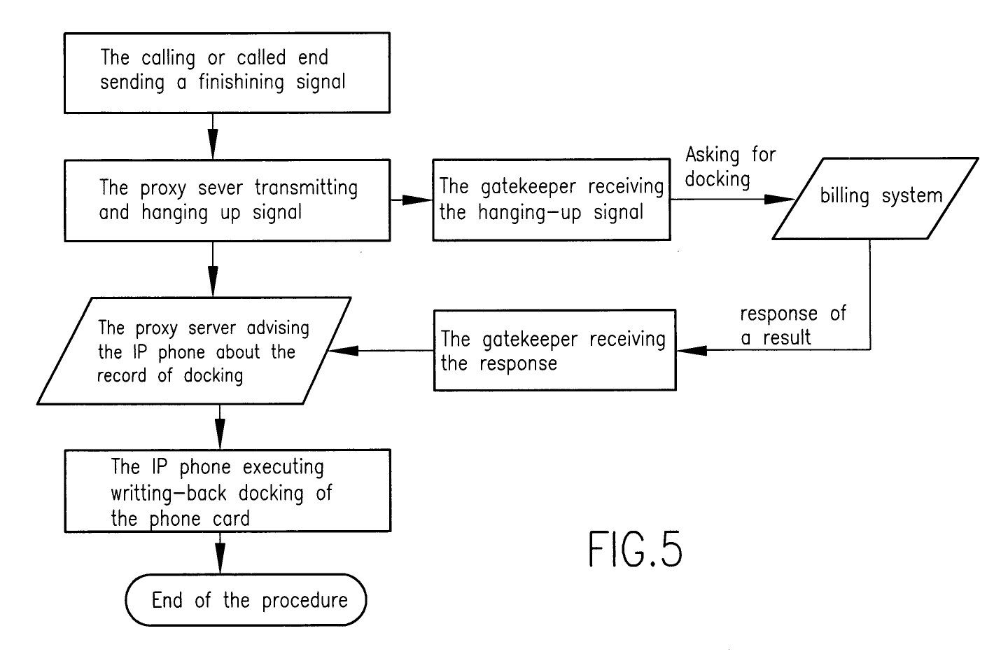

The execution procedure of finishing conversation of the present invention can be referred to FIGS. 4 and 5; the execution procedure of finishing conversation is specified as below, wherein the numbers of articles are corresponding to numbers marked in FIG. 4.
1. When the calling end or the called end finishes conversation, it sends a finishing signal to the proxy server 104.
2. The proxy server 104 advises the gatekeeper 105 about receiving of this finishing signal.
3. The gatekeeper 105 transfers the finishing signal to the billing system 106.
4. The billing system 106 executes an action of docking the remaining sum and transmits the result back to the gatekeeper 105.
5. The gatekeeper 105 then sends the result to the proxy server 104.
6. The proxy server 104 advises the public network telephone 107 about the record of docking the remaining sum.
7. The public network telephone 107 executes writing back on the phone card 110 to dock the fee for conversation this time.

The main idea of the present invention can thus be practices in the above stated embodiment. Evidently, the present invention can publicize a telephone of a network; by providing the public network telephone, it will benefit to any user who wants to dial; this certainly can make network telephones more popularized.

The above embodiment has been described with a phone card, it surely can use a chip card such as a monetary card, credit card etc. to dial a public network telephone.

Particularly, a public network telephone can be provided in a chain store to give users a safe environment; the store can sell phone cards, this can provide the users with convenience and the store can also be provided with trading chance.

Having thus described the technical structure of my invention with practicability and novelty, what I claim as new and desire to be secured by Letters Patent of the United States are:

1. A public network system of a payment mode using a card with a chip, said system comprises:
an IP network with a Voice Over Internet Protocol Gateway and a trunk gateway;
a server end provided with a proxy server, a gatekeeper, a billing system; and
at least a customer end which provides at least a public network telephone and a soft phone having card readers at each of a plurality of particular locations or large chain stores;
with a specific voice communication protocol, said network telephone and said soft phone get in conversation through said IP network; dialing a phone call for conversation is allowed through said IP network and by authorization of said server end when said card with said chip is inserted into one of said card readers.

2. The public network system of a payment mode using a card with a chip as claimed in claim 1, wherein said trunk gateway provides message conversion or communication-procedure conversion between said system and a different protocol standard.

3. The public network system of a payment mode using a card with a chip as claimed in claim 2, wherein said different protocol standard is a Public Switch Telephone Network (PSTN) or an Integrated Service Digital Networks (ISDN).

4. The public network system of a payment mode using a card with a chip as claimed in claim 1, wherein said card with said chip is a phone card.

5. The public network system of a payment mode using a card with a chip as claimed in claim 4, wherein execution procedure of starting conversation is:
1) a phone card is inserted into one of said card readers;
2) said card reader sends out a registration signal;
3) said registration signal is sent to said gatekeeper through said proxy server;
4) said gatekeeper asks said billing system to check state of account after receiving said registration signal;
5) said billing system makes a response to said gatekeeper about said state of account;
6) said gatekeeper decides whether dialing is permitted after receiving said response;
7) said gatekeeper sends a result back to said public network telephone;
8) a user starts to dial;
9) said proxy server analyses a destination number through said gatekeeper;
10) said gatekeeper notices said proxy server after analysis;
11) said proxy server establishes a conversation path with said trunk gateway according to said analysis of said gatekeeper;
12) said trunk gateway asks a local Public Switch Telephone Network company to establish communication with a telephone of said destination number.

6. The public network system of a payment mode using a card with a chip as claimed in claim 4, wherein execution procedure of finishing conversation is:
1) when a calling end or a called end finishes conversation, it sends a finishing signal to said proxy server;
2) said proxy server advises said gatekeeper about receiving of said finishing signal;
3) said gatekeeper transfers said finishing signal to said billing system;
4) said billing system executes an action of docking a remaining sum and transmits a result back to said gatekeeper;
5) said gatekeeper then sends said result to said proxy server;
6) said proxy server advises said public network telephone about a record of docking said remaining sum;
7) said public network telephone executes writing back on said phone card to dock fee for conversation this time.
